(19) United States
(12) Patent Application Publication
(10) Pub. No.: US 2018/0211445 A1
(43) Pub. Date: Jul. 26, 2018

(54) INFORMATION PROCESSING DEVICE, TERMINAL, AND REMOTE COMMUNICATION SYSTEM

(71) Applicant: SHARP KABUSHIKI KAISHA, Sakai city, Osaka (JP)

(72) Inventors: TAKUTO ICHIKAWA, Sakai City (JP); MAKOTO OHTSU, Sakai City (JP); TAICHI MIYAKE, Sakai City (JP)

(21) Appl. No.: 15/745,649

(22) PCT Filed: Jun. 21, 2016
(86) PCT No.: PCT/JP2016/068390

§ 371 Date: Jan. 17, 2018

(30) Foreign Application Priority Data
Jul. 17, 2015 (JP) 2015-143236

(51) Int. Cl. G06T 19/00; H04N 7/15

(52) U.S. Cl. CPC G06T 19/006; G09B 5/02; H04N 7/15

(57) ABSTRACT

A technique capable of giving instructions efficiently to multiple workers who are in the same space but in different positions is provided. An instruction device (1112) includes a feature point detector (1501), a marker information storage unit (1500), an inter-image transformation parameter calculator (1504), and a marker information transformer (1505). The feature point detector (1501) acquires a first image captured at a first viewpoint and a second image captured at a second viewpoint. The marker information storage unit (1500) acquires first positional information being positional information about a marker superimposed on the first image. The inter-image transformation parameter calculator (1504) makes reference to the first image and the second image and calculates an inter-image transformation parameter for transforming the first image to the second image. The marker information transformer (1505) makes reference to the inter-image transformation parameter and transforms the first positional information to second positional information being positional information about a marker superimposed on the second image.

### TECHNICAL FIELD

The present invention relates to an information processing device that performs processing concerned with an image captured in at least two viewpoints, a terminal, and a remote communication system.

### BACKGROUND ART

At a work site where knowledge, experience, and know-how are regarded as important, experts and skilled people often give instructions on work procedure, judgment standards, and how to deal with problems to employees who are not trained for the work. At this time, in a case where a person who gives instructions (hereinafter referred to as an instructor) and a person who receives the instructions (hereinafter referred to as a worker) are at the same place and can communicate face-to-face while giving the instructions, the worker can receive the effective instructions from the worker. However, in a case where the instructor and the worker are not at the same place, the worker cannot receive the effective instructions from the instructor.

Instructions may be given by a manual as a method for a worker to receive instructions from an instructor in the case where the instructor and the worker are not at the same place. This method does not allow the worker to receive instructions on unexpected problems unwritten in the manual and cases requiring judgment based on experience according to circumstances.

As another method for a worker to receive instructions from an instructor in the case where the instructor and the worker are not at the same place, the worker may receive instructions from the instructor at a remote place by using a television telephone (video phone). The worker captures a video of a working spot and a work scene and then transmits the video to the instructor. The instructor conveys instructions mainly by voice responding to the received video. This method allows the worker to receive instructions from the instructor on unexpected problems unwritten in a manual and cases requiring judgment based on experience, according to circumstances. However, the instructor cannot give visual instructions by pointing at a real thing. To solve this problem, the instructor needs to give instructions by using expressions that can specify a position such as “n^{th} from the right and n^{th} from the top” instead of instructions including ambiguous expressions such as “here” and “that”. However, in a case that the worker is constantly moving, a “third” place for the instructor can be a “fourth” place or other places for the worker, and contents of instructions cannot be accurately transmitted. This results in a problem in which working efficiency decreases. Such a conversation that “n^{th} from the right and n^{th} from the top” is different from expressions used in a usual conversation, which also results in a problem in which a heavy load is applied to the instructor.

As a method to solve the problems of instructions by a television phone (video phone), there are means using an Augmented Reality (AR) technology that superimposes and renders Computer Graphics (CG) on a real video. The AR technology can render a mark such as a pattern, a symbol, and a letter created by CG on a video as if the mark is actually at the place. PTL 1 and NPL 1 disclose an AR-type work support method using the AR technology.

PTL 1 and NPL 1 describe a method for presenting a position concerned with visual instructions to a worker by transmitting a video that has been captured (hereinafter referred to as a captured video) from the worker to an instructor and transmitting, from the instructor to the worker, a video (hereinafter referred to as a combined video) in which a mark is disposed at an instruction spot on the video received from the worker. PTL 1 describes a technique for using a head mount video displaying device as a display device by a worker. NPL 1 describes a technique for using a portable terminal as a display device by a worker. The techniques of PTL 1 and NPL 1 are advantageous in that instructions can be given efficiently in comparison with a television phone (video phone) because a spot instructed by an instructor is visually and explicitly indicated.

### CITATION LIST

### Patent Literature

PTL 1: JP 2008-124795 A

### Non Patent Literature

NPL 1: AR support function, NIPPON TELEGRAPH AND TELEPHONE EAST CORPORATION http://www.ntt-east.co.jp/release/detail/20131024_01.html

### SUMMARY OF INVENTION

### Technical Problem

However, the techniques described in PTL 1 and NPL 1 have such a problem that instructing efficiency decreases in a case that multiple workers are in different positions even in the same space. In the case that multiple workers are in different positions even in the same space, a method for giving instructions from an instructor to a worker by using the techniques described in PTL 1 and NPL 1 includes a method for giving instructions by disposing a mark at an instruction spot by an instructor on a video captured by a fixed-point camera and a method for giving instructions by disposing a mark at an instruction spot by an instructor on each video captured by all workers.

In the method for giving instructions by disposing a mark at an instruction spot by an instructor on a video captured by a fixed-point camera, a worker prepares a fixed-point camera that captures a work subject in a prescribed position and transmits a video captured by the fixed-point camera (hereinafter referred to as a fixed-point captured video) to an instructor. The instructor disposes a mark at an instruction spot on the received fixed-point captured video and transmits the video to all workers. This method has such a problem that working efficiency decreases because a position worked by a worker and a position captured by the fixed-point camera do not coincide with each other and the worker needs to visually judge the instruction spot and the working spot.

In the method for giving instructions by disposing a mark at an instruction spot by an instructor on each video captured by all workers, in a case that the instructor gives instructions common to all workers, the instructor cannot give instructions efficiently because the instructor need to give the same instructions to each of the workers. Furthermore, timing at which instructions are given to each of the workers varies, so that the instructor cannot simultaneously give instructions whose content requires immediacy to all the workers. Finally, this method has such a problem that instructing efficiency decreases because the instructor needs to judge a capturing position of each of the workers from the received video to judge an instruction spot.

The present invention has been made in view of the above-mentioned problems, and an object thereof is to provide a technology capable of giving instructions efficiently to multiple workers who are in the same space but in different positions.

### Solution to Problem

In order to solve the problems above, an information processing device according to one aspect of the present invention is an information processing device that performs processing concerned with an image captured in at least two viewpoints. The information processing device includes: an image acquisition unit configured to acquire a first image captured at a first viewpoint and a second image captured at a second viewpoint; a positional information acquisition unit configured to acquire first positional information being positional information about a marker superimposed on the first image; an inter-image transformation parameter calculator configured to make reference to the first image and the second image and calculate an inter-image transformation parameter for transforming the first image to the second image; and a marker information transformer configured to make reference to the inter-image transformation parameter and transform the first positional information to second positional information being positional information about a marker superimposed on the second image.

### Advantageous Effects of Invention

According to the present invention, efficient instructions can be given to multiple workers who are in the same space but in different positions.

### BRIEF DESCRIPTION OF DRAWINGS

FIG. 1 is a schematic diagram illustrating an example of a use scene of a telecommunication device according to the present embodiment.

FIGS. 2A and 2B are diagrams illustrating display contents on screens of working terminals and an instruction device according to the present embodiment. FIG. 2A illustrates the display contents on the screens of the working terminals. FIG. 2B illustrates the display contents on the screen of the instruction device.

FIG. 3 is a configuration diagram illustrating a configuration of a remote communication system according to the present embodiment.

FIG. 4 is a block diagram illustrating an example of a configuration of the instruction device according to the present embodiment.

FIG. 5 is a block diagram illustrating a configuration of a marker information manager according to the present embodiment.

FIG. 6 is a diagram illustrating an example of marker information according to the present embodiment.

FIG. 7 is a diagram for describing processing of combining a video and a marker according to the present embodiment.

FIG. 8 is a flowchart illustrating processing of the instruction device according to the present embodiment.

FIG. 9 is a flowchart illustrating an example of processing of registering and deleting marker information by the marker information manager according to the present embodiment.

FIG. 10 is a block diagram illustrating a configuration of the working terminal according to the present embodiment.

FIG. 11 is a diagram for describing calculation of an inter-image transformation parameter by tracking corresponding pixels according to the present embodiment.

FIG. 12 is a diagram illustrating an example in which directions of two display images are aligned in a display device according to the present embodiment.

FIG. 13 is a diagram illustrating an example in which only one worker screen in a display screen of the display device according to the present embodiment.

FIG. 14 is a diagram illustrating an example in which display contents are different depending on videos of workers according to the present embodiment.

FIGS. 15A and 15B are diagrams illustrating an example in which a capturing range and a capturing direction of an image used in an instruction operation according to the present embodiment are displayed. FIG. 15A illustrates display contents on the screens of the working terminals. FIG. 15B illustrates display contents on the screen of the instruction device.

### DESCRIPTION OF EMBODIMENTS

Hereinafter, embodiments of the present invention will be described in detail with reference to the drawings. Portions having the same function are denoted by the same reference numerals in the drawings, and their repetitive description will be omitted.

### First Embodiment

A basic configuration in the present invention will be described in the present embodiment. Specifically, in Augmented Reality (AR)-type working support that enables working while looking at a displayed combined video formed by combining working instructions, which are created by Computer Graphics (CG), within a captured video, a method for appropriately controlling how a displayed combined video is seen by multiple workers who are in the same space but in different positions will be described.

The present embodiment particularly gives a description of an example of specifying a corresponding feature point by comparing a feature value that represents a feature point detected from a video as a reference and a feature value that represents a feature point detected from a video different from the reference and of obtaining an inter-image transformation parameter. Note that details of the inter-image transformation parameter will be described below.

### Use Scene of Device

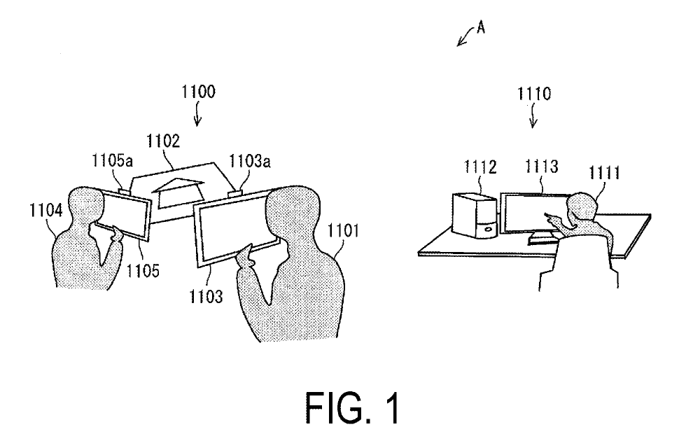

FIG. 1 is a schematic diagram illustrating an example of a use scene of a telecommunication device A according to the present embodiment. A work site 1100 illustrated at the left of FIG. 1 and an instruction room 1110 illustrated at the right of FIG. 1 are located at a distance from each other. This scene is a scene where a worker 1101 and a worker 1104 at the work site 1100 are working while receiving working instructions on a work subject 1102 with a working terminal (terminal) 1103 or 1105 from an instructor 1111 in the instruction room 1110. This is an example in which the worker 1101 and the worker 1104 who are repairing the work subject 1102 are receiving instructions on the repair from the instructor 1111 who supervises the workers.

A camera 1103a and a camera 1105a for capturing are located on the back of the working terminal 1103 and the working terminal 1105, respectively, to be able to capture the work subject 1102. Herein, an image captured by the camera 1103a is referred to as an image captured at a first viewpoint. An image captured by the camera 1105a is referred to as an image captured at a second viewpoint. Each of the working terminal 1103 and the working terminal 1105 can also transmit a captured video to a remote place.

An instruction device (information processing device) 1112 disposed in the instruction room 1110 receives the captured videos transmitted from the working terminal 1103 and the working terminal 1105 at the remote place and can display the videos on a display device 1113. Then, the instructor 1111 gives working instructions to the worker 1101 or the worker 1104 on the display device 1113 while looking at the videos of the working subject displayed on the display device 1113.

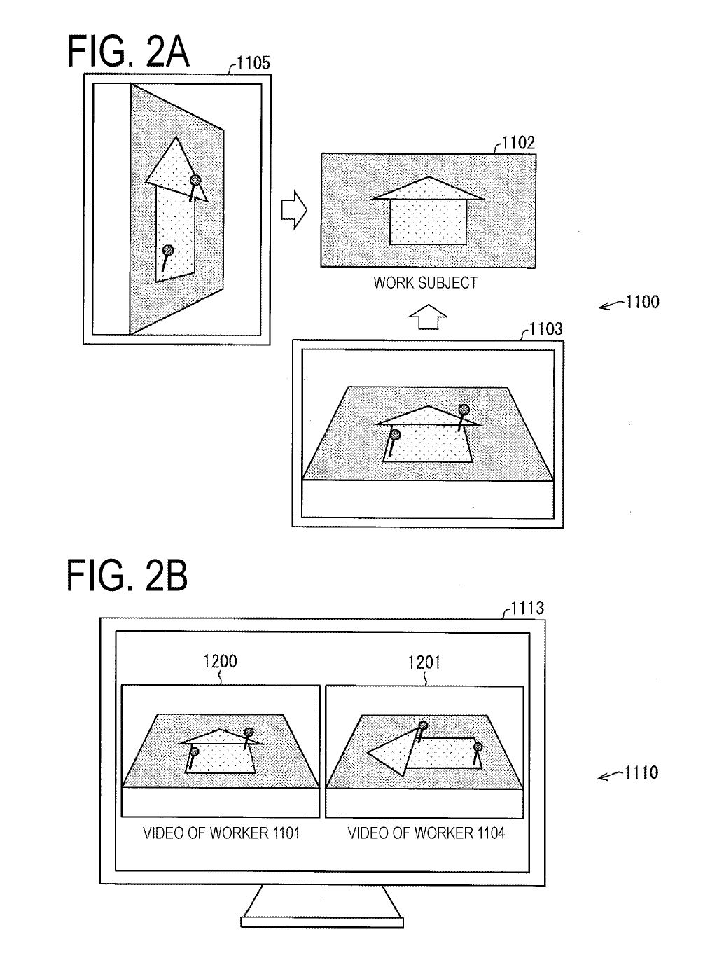

With reference to FIGS. 2A and 2B, display contents displayed on the working terminals 1103, 1105 and the display device 1113 of the instruction device 1112, and how contents of instructions on which AR is superimposed are displayed will be described in detail. FIGS. 2A and 2B are diagrams illustrating display contents on screens of the working terminals 1103, 1105 and the instruction device 1112 according to the present embodiment. FIG. 2A illustrates the display contents on the screens of the working terminals 1103 and 1105. FIG. 2B illustrates the display contents on the screen of the instruction device 1112.

An image 1200 received from the worker 1101 and captured at the first viewpoint and an image 1201 received from the worker 1104 and captured at the second viewpoint are displayed in sections within the screen of the display device 1113 viewed by the instructor 1111. The instructor 1111 can superimpose a pointer, a marker, or the like that is input by using a touch panel function, a mouse function, or the like on the display video 1200 or 1201 and indicates an instruction position. The instruction position indicated by the marker or the like in one of the videos is simultaneously transformed to a corresponding instruction position in the other video, and a marker or the like so as to indicate the instruction position in the other video is displayed. Hereinafter, information for displaying a pointer, a marker, or the like on a display screen is collectively referred to as marker information, which will be described below in detail. The marker information can also include information for displaying a text, a pattern, or the like on a display screen. The marker information includes positional information about markers.

The marker information is transmitted from the instruction device 1112 to the working terminal 1103 or the working terminal 1105, and the working terminals 1103, 1105 that have received the marker information superimpose a marker on a video capturing a work subject and display the video.

Note that the instruction device 1112 may be configured to transmit a video on which a marker is superimposed to the working terminal 1103 or the working terminal 1105, and the working terminals 1103, 1105 may be configured to receive the video on which the marker is superimposed and display the video as it is.

The worker can look at the video in a display unit of the working terminal and can thus visually grasp working instructions from a remote place (instruction room 1110). Note that a marker can be superimposed on a video based on an input of the worker 1101 or the worker 1104, and the workers 1101, 1104 and the instructor 1111 can share the marker information. The terminal of the instructor in FIG. 1 may have any shape, and such a tablet-shaped device that is used by the worker can also be used. The terminal of the worker may also have any shape.

Note that the same applies to a case of three or more workers.

### Remote Communication

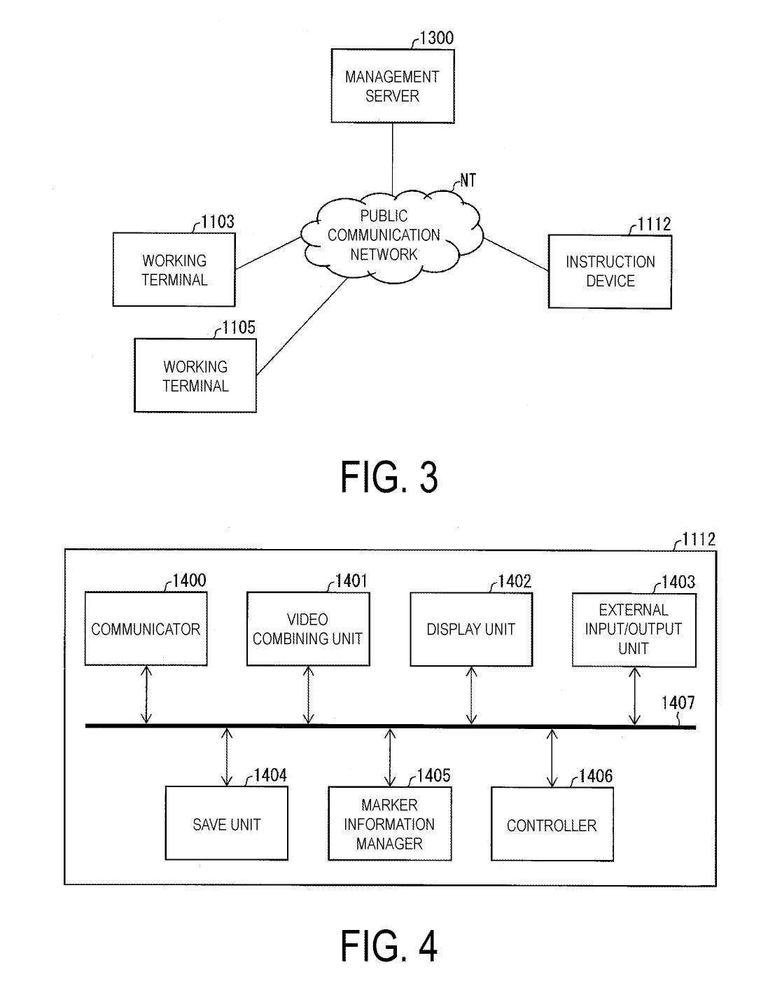

FIG. 3 is a configuration diagram illustrating a configuration of a remote communication system according to the present embodiment. The working terminals 1103, 1105 and the instruction device 1112 are connected to each other through a public communication network (such as the Internet) NT as illustrated in FIG. 3 and can communicate with each other in accordance with a protocol such as TCP/IP and UDP.

The telecommunication device A according to the present embodiment further includes a management server 1300 configured to collectively manage marker information and connected to the same public communication network NT. Note that the working terminal 1103 or the working terminal 1105 can be connected to the public communication network NT through radio communication. In this case, the radio communication can be achieved by, for example, Wireless Fidelity (Wi-Fi; trade name) connection in accordance with international standards (IEEE 802.11) stipulated by Wi-Fi Alliance (the US industry organization). The public communication network such as the Internet is exemplified for a communication network, but, for example, Local Area Network (LAN) used in companies can be used, and a configuration in which the public communication network and LAN are mixed can also be used.

Although FIG. 3 illustrates a configuration including the management server 1300, it is also not problematic in a case where the working terminals 1103, 1105 and the instruction device 1112 directly communicate with each other by incorporating the function of the management server into the instruction device 1112. In the following description, a method for the working terminals 1103, 1105 and the instruction device 1112 to directly communicate with each other will be described. A description of general voice communication processing and video communication processing other than additional screen information that are used in a common video conference system will be omitted without hindrance.

### Example of Configuration

Next, an example of a configuration of the telecommunication device according to the present embodiment will be described. As described above, the telecommunication device A includes the instruction device 1112 of the instructor and the working terminals 1103, 1105 of the workers that will be described one after another.

### Configuration of Instruction Device

FIG. 4 is a block diagram illustrating an example of a configuration of the instruction device 1112 according to the present embodiment.

The instruction device 1112 includes a communicator 1400, a video combining unit 1401, a display unit 1402, an external input/output unit 1403, a save unit 1404, a marker information manager 1405, a controller 1406, and a data bus 1407. The communicator 1400 receives videos and marker information transmitted from the outside and transmits marker information created inside to the outside. The video combining unit 1401 combines a marker indicating the marker information with a video. The display unit 1402 displays a combined video. The external input/output unit 1403 receives an input from a user. The save unit 1404 saves videos or output results of video processing, the marker information, and various pieces of data used in the video processing. The marker information manager 1405 manages the marker information. The controller 1406 controls the entire instruction device 1112. The data bus 1407 is used for data exchanges among blocks.

The communicator 1400 is a processing block constituted by a Field Programmable Gate Array (FPGA), an Application Specific Integrated Circuit (ASIC), or the like and configured to transmit and receive data to and from the outside. Specifically, the communicator 1400 receives a video symbol and marker information transmitted from the working terminal described below and performs processing of transmitting the marker information created inside. The video symbol is data on which encoding suitable for encoding a moving picture is executed and data encoded by, for example, H.264. H.264 encoding is one of compression encoding standards of moving picture data and is a technique stipulated by ISO (International Standardization Organization).

The video combining unit 1401 is constituted by FPGA and ASIC or a Graphics Processing Unit (GPU) and performs processing of combining marker information managed in the marker information manager 1405, which is described below, with an input video. The marker information is information needed for creating contents of instructions that can be visually expressed such as a marker and a pointer.

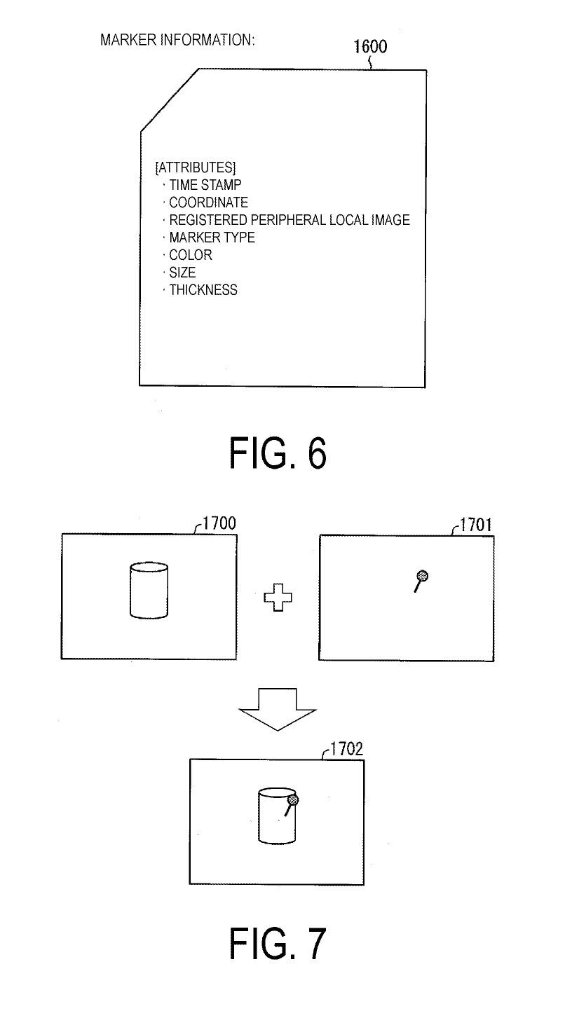

FIG. 6 is a diagram illustrating an example of marker information 1600 according to the present embodiment. As illustrated in FIG. 6, the marker information 1600 includes various attributes (ID, time stamp, coordinate, registered peripheral local image, marker type, color, size, thickness) and is an information group for controlling display states such as a position and a shape. The attributes illustrated in FIG. 6 are examples. The marker information 1600 may include a part of the attributes illustrated in FIG. 6 or include supplemental attribute information in addition to the attributes illustrated in FIG. 6.

FIG. 7 is a diagram for describing processing of combining a video 1700 and a marker 1701 according to the present embodiment. As illustrated in FIG. 7, the marker 1701 (position and shape) created according to an attribute included in the marker information 1600 is combined with the video 1700 that has been input to create a combined video 1702.

The display unit 1402 is constituted by a Liquid Crystal Display (LCD), an Organic Electro Luminescence Display (OELD), or the like and displays a combined video output from the video combining unit 1401, results of video processing, images saved in the save unit 1404, and an User Interface (UI) for controlling a device. The display unit 1402 can include a function as a touch panel that can operate a terminal by pressing its display surface, and using the function can specify a place at which the above-described marker is disposed. Note that the display unit 1402 may be externally disposed on the outside of the instruction device 1112 via the external input/output unit 1403.

The external input/output unit 1403 includes an input/output port such as a Universal Serial Bus (USB) and a High Definition Multimedia Interface (HDMI; trade name) and operates as an interface with an external storage.

The save unit 1404 is constituted by, for example, a main memory such as a Random Access Memory (RAM) and an auxiliary memory such as a hard disk. The main memory is used for temporarily holding image data and image processing results. The auxiliary memory stores data, such as captured image data and image processing results, to be saved long-term as a storage.

The marker information manager 1405 is constituted by FPGA, ASIC, or the like and manages marker information. Specifically, the marker information manager 1405 inserts and deletes the marker information, successively updates a position of the marker according to movement of a video, and performs tracking. Detailed information about the marker information manager 1405 will be described below.

The controller 1406 is constituted by a Central Processing Unit (CPU) or the like, and commands/controls processing in each processing block and controls an input and an output of data.

The data bus 1407 is a bus for data exchanges among units.

### Marker Information Manager

Next, an example of a detailed configuration and an example of operations in the marker information manager 1405 of the present invention will be described.

In the present invention, the instructor 1111 uses the display device 1113 to superimpose a marker on at least one video among videos captured by multiple working terminals. At this time, the instruction device 1112 transforms marker information to a position in the other video that corresponds to the superimposed position of the marker and transmits the marker information to the other working terminal. The other working terminal receives and makes reference to the marker information and combines the marker with the other video captured by the terminal. In this way, the marker in the position corresponding to the superimposed position in the original video is displayed in the video of the other working terminal.

The instruction device 1112 also includes a tracking function that changes a superimposed position of a marker according to movement of a worker himself/herself or movement of a video caused by an operation changing an acquisition video range due to zooming or the like by a worker or an instructor. The tracking function allows a video varying at any time to be displayed such that a marker follows the video.

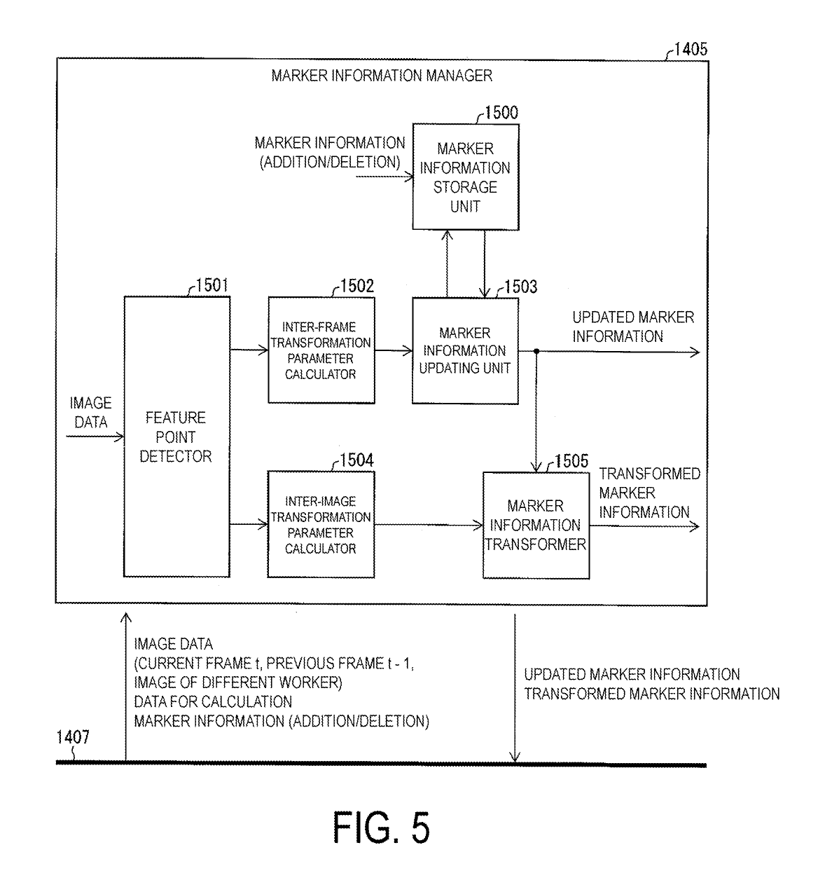

Hereinafter, a case that an instructor superimposes a marker on an image with reference to the image 1200 captured at the first viewpoint (hereinafter referred to as a reference video) received from the worker 1101 will be described. FIG. 5 is a block diagram illustrating a configuration of the marker information manager 1405 according to the present embodiment.

As illustrated in FIG. 5, the marker information manager 1405 includes a feature point detector (image acquisition unit, frame acquisition unit) 1501, an inter-frame transformation parameter calculator 1502, a marker information updating unit 1503, a marker information storage unit (marker information acquisition unit) 1500, an inter-image transformation parameter calculator 1504, and a marker information transformer 1505. The feature point detector 1501 inputs multiple pieces of image data and detects a feature point in each image. The inter-frame transformation parameter calculator 1502 calculates a transformation parameter between frames needed for image transformation between images in a current frame (t) and a previous frame (t−1) in a captured video as a reference. The marker information updating unit 1503 updates a superimposed position of a marker that is already superimposed by using a transformation parameter between frames. The marker information storage unit 1500 stores marker information being managed. The inter-image transformation parameter calculator 1504 calculates an inter-image transformation parameter for transformation between images of different workers. The marker information transformer 1505 transforms the updated marker information by using the inter-image transformation parameter such that the updated marker information becomes marker information designed for an image of a working terminal different from the image as the reference.

### Feature Point Detection

The feature point detector 1501 receives an image in a current frame (t) and an image in a previous frame (t−1) in a reference video from the data bus 1407 and calculates feature points. Herein, the feature point is, for example, such a pixel that multiple edges are joined, and information about the feature point can be calculated by using, for example, Speeded Up Robust Features (SURF). The information about the feature point is positional information about a detected feature point in image coordinates and descriptive information (feature value) that can specify the feature point. A technique for detecting a feature point is not limited to SURF, and can use any or multiple of various pieces of feature point data called a Prewitt filter, a Laplacian filter, a Canny filter, and a Scale-Invariant Feature Transform (SIFT). The calculated feature points and the feature value that represents the feature points are output to the inter-frame transformation parameter calculator 1502. The feature point detector 1501 further receives an image of the other working terminal (for example, an image from the working terminal 1105) from the data bus 1407, similarly calculates feature points and a feature value, and outputs the results to the inter-image transformation parameter calculator 1504.

### Method for Tracking Marker Information

The inter-frame transformation parameter calculator 1502 performs the following processing when receiving the information about the feature points in the current frame (t) and the previous frame (t−1) in the reference video from the feature point detector 1501, and calculates an inter-frame transformation parameter that transforms arbitrary image coordinates on the image in the previous frame to corresponding image coordinates in the current frame.

The multiple detected feature points are FPₜ₋₁(1), 1=1, . . . , n. Herein, a subscript of t−1 is a frame number and 1 in parentheses is an index of each feature point.

A corresponding position in the frame (t) needs to be obtained from the feature point FPₜ₋₁ in the calculated frame (t−1). In a case where a time interval between the frames is sufficiently short, movement of a captured object decreases. By using this, a point corresponding to an original feature point can be obtained by searching a relatively narrow range with reference to a position of the original feature point. It can be achieved with, for example, a function of Open Source Computer Vision Library (OpenCV) being a general-purpose API of a computer vision, and a corresponding position in a next frame can be calculated with a function called cvCalcOpticalFlowLK. This function uses an algorithm of Lucas-Kanade and one of methods for obtaining a position of a corresponding pixel in a next frame. Any other methods can also be used.

As described above, a position of an extracted feature point in the (t−1)^{th} frame and a position of a point in the (t)^{th} frame corresponding to the extracted feature point can be obtained, so that the video combining unit 1401 transforms the whole image by using this corresponding relationship. In other words, a change in images between frames is expressed as a transformation of images. Specifically, the following transformation expression is used. With this transformation expression, a pixel (m, n) in the (t−1)^{th} video frame can be transformed to (m′, n′) in the (t)^{th} frame.

$$\begin{matrix}[ Expression 1 ] & \\ ( \begin{matrix}{m}^{′} \\ {n}^{′} \\ 1\end{matrix} ) = {H}^{*} ( \begin{matrix}m \\ n \\ 1\end{matrix} ) & ( Expression 1 )\end{matrix}$$

H* in this transformation (Expression 1) is a 3-by-3 matrix called a homography matrix. The homography matrix is a matrix capable of performing a projective transformation on two images and approximating a change between successive frames with the above-described assumption.

$$\begin{matrix}[ Expression 2 ] & \\ {H}^{*} ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) & ( Expression 2 )\end{matrix}$$

Herein, in a case where each element in the homography matrix is defined as in Expression 2, the inter-frame transformation parameter calculator 1502 obtains a value of each of the elements in 3-by-3 so as to minimize a coordinate transformation error by Expression 1 in a corresponding relationship of feature points between successive frames. Specifically, the inter-frame transformation parameter calculator 1502 calculates each of the elements so as to minimize the following expression (Expression 3).

$$\begin{matrix}[ Expression 3 ] & \\ {arg min}_{{h}_{11} , … , {h}_{33}} ( {\sum }_{l = 1 , … , n} {( {m}_{t} - \frac{{h}_{11} {m}_{t - 1} + {h}_{12} {n}_{t - 1} + {h}_{13}}{{h}_{31} {m}_{t - 1} + {h}_{32} {n}_{t - 1} + {h}_{33}} )}^{2} + {( {n}_{i} - \frac{{h}_{21} {m}_{t - 1} + {h}_{22} {n}_{t - 1} + {h}_{23}}{{h}_{31} {m}_{t - 1} + {h}_{32} {n}_{t - 1} + {h}_{33}} )}^{2} ) & ( Expression 3 )\end{matrix}$$

Herein, argmin (⋅) is a function that calculates a parameter below argmin minimizing the inside of parentheses. (mₜ₋₁(1), nₜ₋₁(1)) and (mₜ(1), nₜ(1)) respectively represent coordinates (FPₜ₋₁(1)) of the feature point in the (t−1)^{th} frame and corresponding coordinates (FPₜ(1)) of the feature point in the (t−1)^{th} frame.

As described above, the inter-frame transformation parameter calculator 1502 can obtain a matrix and its transformation expression that transform coordinates in a video in a previous frame to corresponding coordinates in a current frame. This matrix is referred to as a transformation parameter.

The inter-frame transformation parameter calculator 1502 calculates a transformation parameter expressed by Expression 3 and transmits the transformation parameter to the marker information updating unit 1503. The marker information updating unit 1503 receives the transformation parameter and preforms updating of Expression 1. At this time, the marker information is stored in the marker information storage unit 1500. The marker information updating unit 1503 transforms the coordinates in the image in the stored marker information. The updated marker information is transmitted to the marker information storage unit 1500 again and stored in the marker information storage unit 1500 for updating a next frame. The updated marker information is also output to the data bus 1407 and then transmitted to the video combining unit 1401 and the communicator 1400.

The marker information storage unit 1500 adds and deletes the marker information and stores the marker information updated by the marker information updating unit 1503. When the marker information is added, deleted, and updated, the marker information storage unit 1500 confirms the marker information as a subject according to an ID being one of the attributes of the marker information, so that the marker information can be deleted, added, and updated.

### Method for Transforming Marker Information for Other Working Terminal

The inter-image transformation parameter calculator 1504 calculates a parameter for transforming an image between different workers. This method may be the same as the above-described method by the inter-frame transformation parameter calculator. The inter-image transformation parameter calculator 1504 may make reference to the feature points, which are detected by the feature point detector 1501, in the two images from the other working terminals, calculate an inter-image transformation parameter of Expression 2, and output the inter-image transformation parameter to the marker information transformer 1505. In the description above, the feature points to which the inter-image transformation parameter calculator 1504 needs to make reference are corresponding portions between the two images. The corresponding portions are not limited to the feature points, and an inter-image transformation parameter may be calculated by making reference to corresponding portions other than the feature points.

When receiving a transformation parameter from the inter-image transformation parameter calculator 1504, the marker information transformer 1505 uses the above-described Expression 1 to perform transformation on coordinates in the updated marker information according to an image for a different worker. The transformed marker information is also output to the data bus 1407 and then transmitted to the video combining unit 1401 and the communicator 1400, similarly to the updated marker information described above.

### Processing of Instruction Device

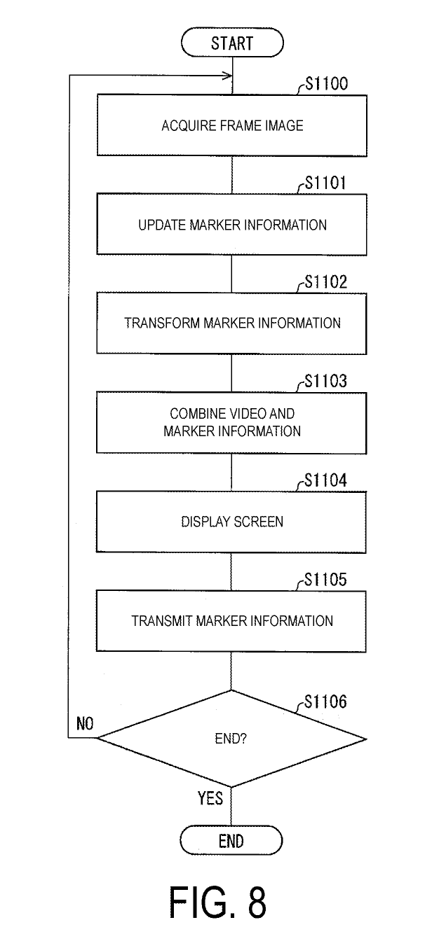

Next, a procedure of processing performed by the instruction device 1112 of the present embodiment will be described with reference to FIG. 8. FIG. 8 is a flowchart illustrating processing of the instruction device 1112 according to the present embodiment.

FIG. 8 illustrates processing, by the instruction device 1112, of receiving videos transmitted from multiple working terminals from the outside, updating marker information registered in the marker information manager 1405, and displaying the marker information on the display unit 1402, and illustrates processing, by the instruction device 1112, of outputting the updated marker information from the communicator 1400 to the outside.

By the function of the communicator 1400, when receiving a video symbol from the outside (for example, a working terminal described below), the instruction device 1112 performs decoding and reproduces the original video signal (Step S1100). Subsequently, the instruction device 1112 outputs the video signal to the save unit 1404 and also outputs the video signal to the marker information manager 1405 in a case that the decoded video signal is the reference video described above. When receiving the image of the reference video, the marker information manager 1405 further acquires a previous frame image in a previous frame in the reference video from the save unit 1804.

The marker information manager 1405 updates coordinates in an image in the stored marker information based on an inter-frame transformation parameter calculated with the image in the current frame and the image in the previous frame in the reference video (Step S1101). The marker information manager 1405 updates the stored marker information based on the updated results and further outputs the updated results to the video combining unit 1401. Then, the marker information manager 1405 acquires data about the current frame of the image of the working terminal, which is not the reference video saved in the save unit 1404, and separately transforms the marker information updated in Step S1101 based on an inter-image transformation parameter calculated from a corresponding relationship with the feature point in the current frame in the reference video described above (Step S1102).

The transformed marker information is marker information for the other working terminal different from the reference video. The marker information manager 1405 outputs the transformed marker information to the video combining unit 1401. The video combining unit 1401 superimposes a marker on each of the videos and combines them together by using the updated marker information and the transformed marker information received from the marker information manager 1405 (Step S1103). Subsequently, the video combining unit 1401 transmits the combined video to the display unit 1402, and the display unit 1402 displays the combined video on a screen (Step S1104). The marker information manager 1405 outputs the updated marker information and the transformed marker information to the communicator 1400, and the communicator 1400 transmits these pieces of marker information to the corresponding working terminals (Step S1105). The controller 1406 determines whether to continue the processing of the instruction device 1112 (Step S1106). In a case where the processing is continued (YES in S1106), the processing is returned to Step S1100 and the above-described processing is repeated. In a case where the processing is ended (NO in S1106), all the processing is ended.

### Processing of Marker Information Manager

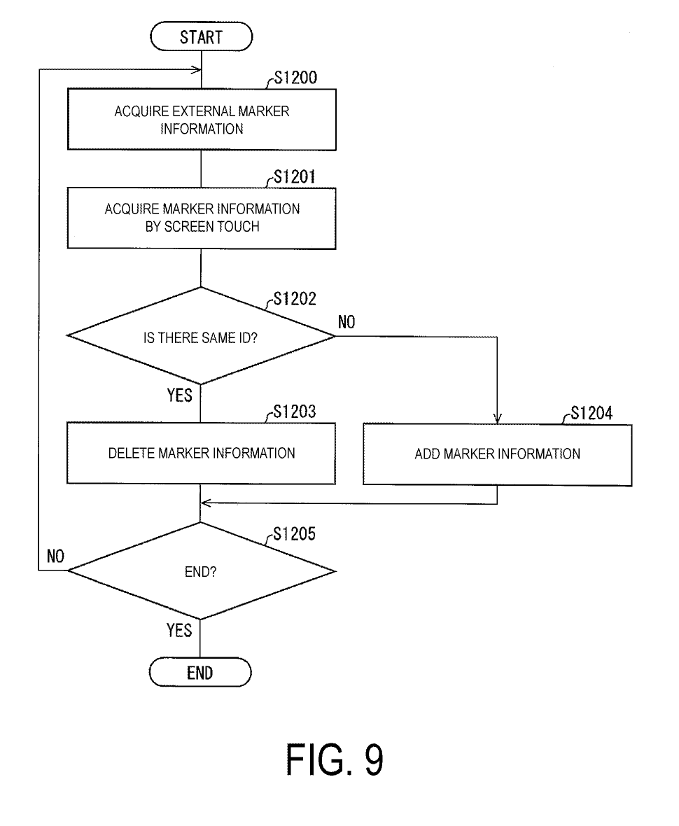

FIG. 9 is a flowchart illustrating an example of processing of registering and deleting marker information by the marker information manager 1405 according to the present embodiment.

As illustrated in FIG. 9, when receiving marker information transmitted from the outside of the instruction device 1112, the communicator 1400 outputs the marker information to the marker information manager 1405 (Step S1200). On the other hand, in a case that an instructor superimposes a marker on a position input by pressing a display screen, the display unit 1402 outputs the marker information according to the marker to the marker information manager 1405 (Step S1201). When receiving the marker information input from the outside and the marker information created by the display unit 1402, the marker information manager 1405 makes reference to an ID included in the marker information stored inside and determines whether there is marker information including the same ID (Step S1202).

In a case where there is marker information including the same ID (YES in Step S1202), the marker information manager 1405 deletes all marker information including the same ID (Step S1203). In a case where there is no marker information including the same ID (NO in Step S1202), the marker information manager 1405 adds the marker information as new marker information (Step S1204).

The controller 1406 determines whether to continue the processing of the instruction device 1112 (Step S1205). In a case where the processing is continued (NO in S1205), the processing is returned to Step S1100 and the above-described processing is repeated. In a case where the processing is ended (YES in S1205), all the processing is ended.

The configuration and the contents of the processing of the instruction device 1112 are described above. Note that the marker information manager 1405 included in the instruction device 1112 can be independently formed externally. In this case, the instruction device 1112 is constituted by all processing blocks except for the display unit 1402 and can be independently formed as the marker management server 1300 described above.

### Configuration of Working Terminal

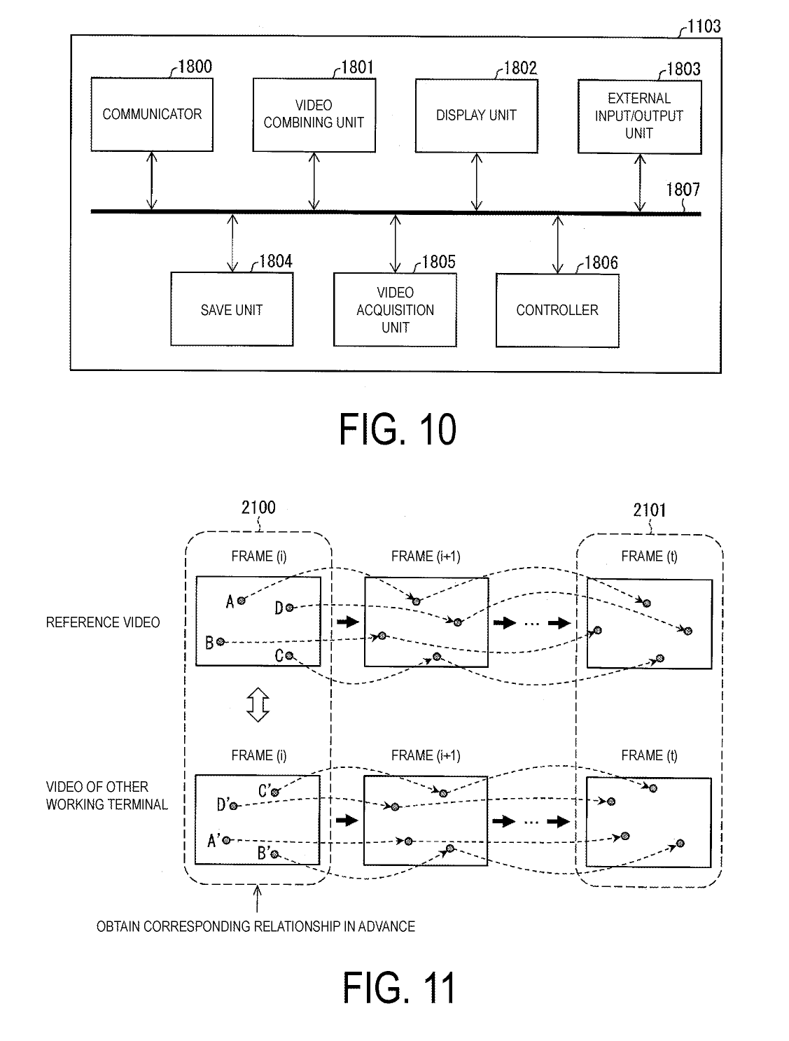

Next, a configuration of the working terminal 1103 will be described with reference to FIG. 10. FIG. 10 is a block diagram illustrating the configuration of the working terminal 1103 according to the present embodiment.

A difference in configuration between the working terminal 1103 (as well as the working terminal 1105) and the instruction device 1112 is associated with a video acquisition unit and a marker manager. In other words, the working terminal 1103 includes a video acquisition unit 1805 configured to acquire a video but does not include a marker manager. The other configurations are the same as those of the instruction device 1112. That is to say, a communicator (transmitter, positional information acquisition unit) 1800, a video combining unit 1801, a display unit 1802, an external input/output unit 1803, a save unit 1804, a controller 1806, and a data bus 1807 have the same function as that of the communicator 1400, the video combining unit 1401, the display unit 1402, the external input/output unit 1403, the save unit 1404, the controller 1406, and the data bus 1407, respectively.

The video acquisition unit 1805 includes an optical part for capturing an image as a captured space into the working terminal 1103 and an imaging device such as a Complementary Metal Oxide Semiconductor (CMOS) and a Charge Coupled Device (CCD), and outputs image data created based on an electrical signal obtained through photoelectric conversion to the data bus 1807. The video acquisition unit 1805 may output captured information as original data to the data bus 1807 or output captured information as video data subjected to image processing (such as brightness imaging and noise removing) in advance to be easily processed in a video processor, which is not illustrated, to the data bus 1807. The video acquisition unit 1805 may also be configured to output both data. Furthermore, the video acquisition unit 1805 can be configured to send a camera parameter such as an f number and a focal distance during capturing.

The video combining unit 1801 combines the acquired video with the marker information transmitted from the outside, and the display unit 1802 displays the combined video. At the same time, the communicator 1800 performs encoding suitable for the above-described moving picture signal on the combined video and outputs the combined video as a video symbol to the outside (for example, the instruction device 1112 described above).

With the configuration described above, in the AR-type working support that enables working while looking at a displayed combined video formed by combining working instructions, which are created by CG, with a captured video, a method for appropriately controlling how a displayed combined video is seen by multiple workers who are in the same space but in different positions can be provided.

### Second Embodiment

In calculation of an inter-image transformation parameter for a video between multiple working terminals, a second embodiment performs processing of updating corresponding points at any time used in the calculation of the inter-image transformation parameter to obtain the corresponding points with start from a prescribed state. In this way, the second embodiment can calculate an inter-image transformation parameter more precisely than the first embodiment. Corresponding points are corresponding portions between two images. The corresponding portions are not limited to the corresponding points, and an inter-image transformation parameter may be calculated by making reference to portions other than the corresponding points.

Hereinafter, a method for calculating an inter-image transformation parameter will be described while differences between the first embodiment and the second embodiment are illustrated.

The first embodiment specifies a corresponding feature point by comparing a feature value that represents a feature point detected from a video as a reference and a feature value that represents a feature point detected from a video of a working terminal different from the reference and obtains an inter-image transformation parameter of Expression 2 described above. However, errors in the corresponding relationship may increase in a case that capturing directions and positions of the working terminals are greatly different. Thus, the present embodiment uses a method for calculating a transformation parameter by updating coordinates of corresponding points at any time starting from a prescribed state in which a corresponding relationship is clear in advance.

Herein, the state in which the corresponding relationship is clear in advance is particularly an example as follows.

A first method is a method for specifying a point that needs to be instructed actually with a hand or a finger and capturing its state to confirm the point that needs to be instructed. When a work subject is captured with a working terminal, for example, one of workers points at an arbitrary place of the work subject. In this way, in a case where the pointed place is in the captured video, its position can be confirmed by each working terminal. When four or more positions are confirmed manually, a transformation parameter of Expression 2 described above can be calculated and a more accurate transformation parameter can be obtained.

A second method is a method for setting a state in which the above-described false corresponding relationship is less likely to occur, that is to say, a state in which working terminals are placed in the same positions and a corresponding relationship is accurately obtained. In this case, the capturing directions and the positions of the working terminals almost coincide with each other, so that the corresponding relationship can be easily obtained and its precision can be also increased.

In addition to the methods above, any methods can be used as long as a method obtains a relationship between points corresponding to each other in videos acquired by multiple working terminals.

In the above method, it is assumed that a point in an obtained reference video is P_{base}(j, i) and a point in a video of a working terminal different from the reference is P_{tab}(j, i) (j is a number indicating a corresponding point where j=0, . . . , 3. i is a frame number). In other words, P_{base}(0, i) and P_{tab}(0, i), . . . , P_{base}(3, i) and P_{tab}(3, i) are points corresponding to each other.

FIG. 11 is a diagram for describing calculation of an inter-image transformation parameter by tracking corresponding pixels according to the present embodiment. As illustrated in 2100 of FIG. 11, a point A and a point A′, a point B and a point B′, . . . , and a point D and a point D′ correspond to each other.

Next, the marker information updating unit 1503 calculates movement of each of the points between frames. The method for updating an inter-frame transformation parameter described above may be used for calculating movement between frames which can be calculated as follows.

[Expression 4]

Pₛ(j,t)=[Hₛ*(t−1)× . . . ×Hₛ*(i)]×P(j,i)

(S∈{base,tab}) (Expression 4)

s is a sign indicating whether a video is from a working terminal, and Hₛ*(i) indicates a transformation parameter between frames that transforms a frame (i) to a frame (i+i). This transformation parameter is calculated by the same method as that of the inter-frame transformation parameter calculator 1502 described above.

As described above, four points for obtaining a corresponding relationship in the frame i can be successively transitioned to the inside of a video in a frame t (see 2101 in FIG. 11).

Finally, the corresponding points obtained from the above-described method are used to calculate a parameter of Expression 2 described above, and a transformation parameter between images can be obtained.

An example of processing with four pixels is illustrated above, but the number of points is not limited to four and may be more than four.

As described above, a transformation parameter between images can be precisely calculated by tracking points clearly corresponding to pixels with start of a state in which the corresponding pixels are clear.

### Third Embodiment

In a third embodiment, a description is given to a method for transforming a video of each working terminal displayed on the display device 1113 of the instruction device 1112 to a video from the same viewpoint by using the inter-image transformation parameter described above and displaying the video from the same viewpoint. In the first embodiment, a screen is divided into sections and a video from each working terminal is displayed as it is. For this reason, regardless of the same captured work subject, videos are displayed from different viewpoints as illustrated in FIGS. 2A and 2B depending on a positional relationship between workers. Accordingly, an instructor needs to superimpose a marker while grasping (transforming) a position of a viewpoint with respect to the video, but it is sometimes difficult to superimpose a marker on the same position of different videos. Thus, in the present embodiment, a description is given to a method for displaying videos projected on a screen from a viewpoint of a reference video such that the videos are displayed from the same viewpoint.

As described above, an arbitrary point in the reference video can be transformed to coordinates in a video of a working terminal different from the reference by using the transformation parameter of Expression 2 and the transformation expression of Expression 1. Herein, Expression 1 is changed to an expression below.

$$\begin{matrix}[ Expression 5 ] & \\ ( \begin{matrix}m \\ n \\ 1\end{matrix} ) = {H}^{* - 1} ( \begin{matrix}{m}^{′} \\ {n}^{′} \\ 1\end{matrix} ) & ( Expression 5 )\end{matrix}$$

Herein, H*⁻¹ is an inverse matrix of the transformation matrix described above. (m′, n′) is coordinates in the reference video, and (m, n) indicates coordinates in a video of a working terminal different from the reference.

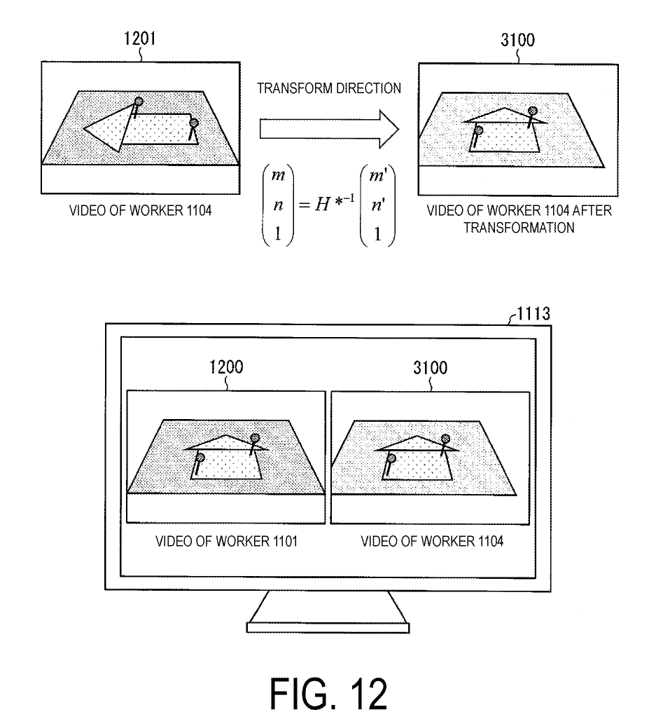

According to Expression 5, arbitrary coordinates in the video of the working terminal different from the reference can be transformed to coordinates in the reference video. An image created by transforming all pixels in the image by Expression 5 is an image from the same viewpoint as that of the reference image. FIG. 12 is a diagram illustrating an example in which viewpoints of two display images are the same in the display device 1113 according to the present embodiment. As illustrated in the display device 1113 of FIG. 12, the video of the worker 1104 is transformed from a video 1201 to a video 3100 and displayed from the same viewpoint as that of the video 1200.

Note that in a case where a created image does not include a pixel corresponding to that of an image before transformation, a nearby pixel may be used for interpolation. An arbitrary technique may be used as an interpolation method. For example, a nearest neighbor method is used to interpolate pixels. The video combining unit (image transformer) 1401 performs the processing above.

The method for transforming a video of each worker and displaying the video such that a viewpoint of the video coincides with a viewpoint of the reference video is described above. A video can be transformed and displayed such that the video matches one of videos of workers, which is not a reference image, by using a similar method. In this case, videos may be switched manually by an instructor or a worker during working.

As described above, the method for making viewpoints of videos transmitted from multiple working terminals uniform and displaying the videos on a screen looked by an instructor can be provided.

### Fourth Embodiment

In a fourth embodiment, a description is given to a method for selecting one of videos of workers projected on the display device 1113 of the instruction device 1112 and giving instructions.

As illustrated in FIGS. 2A and 2B, screens of workers are displayed in the display device 1113 by dividing the screen of the display device 1113 into sections. An increase in the number of workers may reduce the size of a display region of a video of each worker displayed on the display device 1113 and may decrease instructing efficiency of the instructor 1111.

To deal with the case above, the instructor first selects one of the video from the worker 1101 and the video from the worker 1104 as a screen to be used for instructions from the display state as illustrated in FIGS. 2A and 2B.

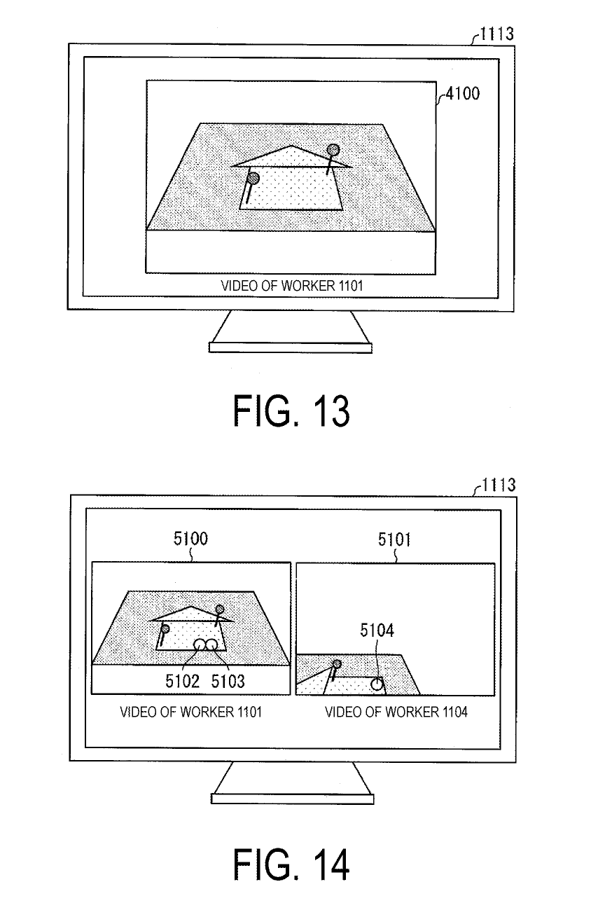

FIG. 13 is a diagram illustrating an example in which only one worker screen in the display screen of the display device 1113 according to the present embodiment. For example, as illustrated in FIG. 13, the display device (display unit, instruction receiver) 1113 displays only the video from the worker 1101 selected by the instructor. When a marker is superimposed on a video 4100, the instruction device 1112 uses Expression 1 to update marker information corresponding to the superimposed marker and transmits the marker information to each of the working terminal 1103 and the working terminal 1105. In this method, the display device 1113 of the instruction device 1112 displays only one video of the worker, so that the size of the display region is not reduced and the instructing efficiency of the instructor does not decrease.

### Fifth Embodiment

In a fifth embodiment, a description is given to a method for displaying a capturing position and a capturing orientation (capturing direction) used in an instruction operation by the instructor 1111 on the working terminal 1103 or the working terminal 1105 by using the inter-image transformation parameter described above.

When an instructor verbally explains marker information already disposed or a feature of a captured subject and instructions of a place such as an instruction spot to multiple workers, it is conceivable that the number of places that correspond to the instruction spot may differ depending on workers.

This case is described with reference to FIG. 14. FIG. 14 is a diagram illustrating an example in which display contents are different depending on videos of workers according to the present embodiment. When the instructor explains while looking at the screen of the worker 1104, it is assumed that the instructor explains an instruction position 5104 with an expression of, for example, a “round marker”. At this time, marker information 5102 and marker information 5103 that correspond to the “round marker” are projected on the video of the worker 1101, thereby causing a case that which video the instructor is explaining at present cannot be judged.

Furthermore, when the instructor verbally explains marker information already superimposed or a feature of a captured subject and a direction of an instruction spot to multiple workers, it is conceivable that directions of places that correspond to the instruction spot may differ depending on workers.

This case is described with reference to FIGS. 2A and 2B. It is assumed that the instructor gives instructions of work performed in a right direction while looking at the screen of the working terminal 1105 of the worker 1104. The instructed work is work in a downward direction in the screen of the working terminal 1103 for the worker 1101 and different from the verbal contents of the instructions, thereby causing work that cannot be accurately performed.

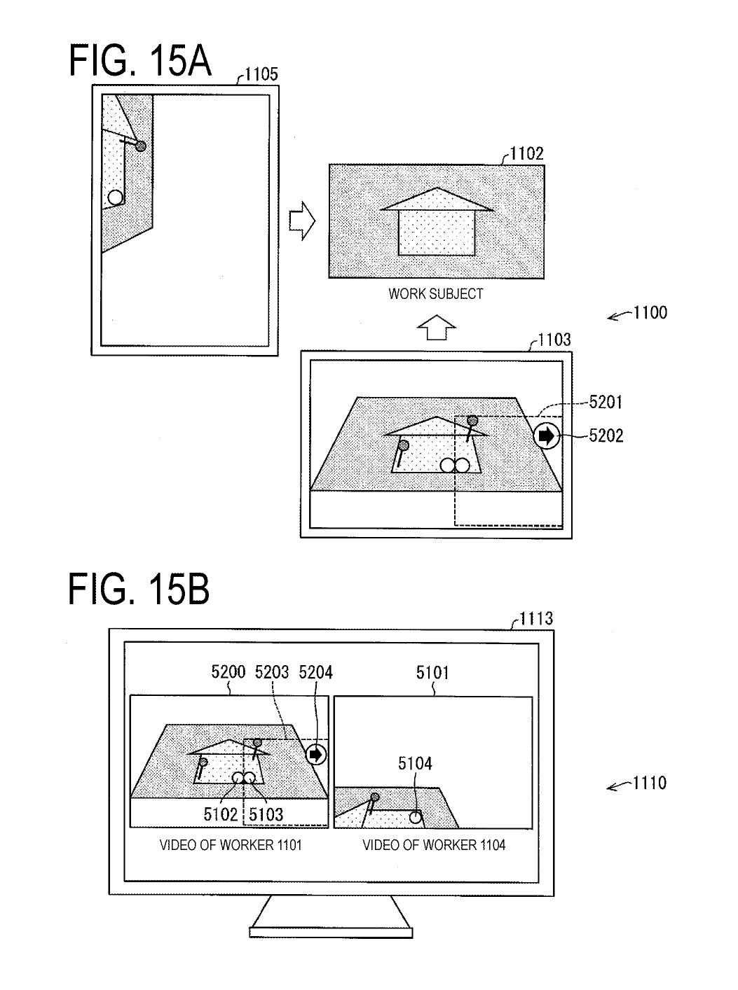

As a method for dealing with the case above, FIGS. 15A and 15B are diagrams illustrating an example in which a capturing range and a capturing direction of an image used in an instruction operation according to the present embodiment are displayed. FIG. 15A illustrates display contents on the screens of the working terminals 1103, 1105. FIG. 15B illustrates display contents on the screen of the instruction device 1112.

As illustrated in FIGS. 15A and 15B, there is a method for superimposing a frame 5201 expressing a capturing range of an image used for instructions of the instructor 1111 and a mark 5202 expressing a capturing direction on the video of the working terminal 1103 by the video combining unit (information combining unit) 1401 and for displaying the video by the display unit 1402. This method clarifies a range and a direction of a video looked by an instructor for explanation on a video of a worker.

Hereinafter, a method for calculating the frame 5201 and the mark 5202 by the marker information manager (information combining unit) 1405 will be described. As described above, an arbitrary point in the reference video can be transformed to coordinates in a video of a working terminal different from the reference by using the transformation parameter of Expression 2 and the transformation expression of Expression 1. According to Expression 1, coordinates of four corners in the reference video are then transformed to calculate a display range of the reference video in the video of the working terminal different from the reference. It is assumed that this calculated display range is the frame 5201. Furthermore, a capturing direction of the reference video in the video of the working terminal different from the reference video can be calculated by transforming a straight line connecting a lower left corner and an upper left corner in the reference video according to Expression 1. It is assumed that this calculated direction is the mark 5202.

Herein, the calculated range and direction may be superimposed and displayed as a frame 5203 and a mark 5204, respectively, on a video 5200.

### With Regard to First to Fifth Embodiments

In each of the embodiments described above, configurations or the like illustrated in the accompanying drawings are merely examples, are not limited thereto, and can be appropriately modified within the scope where the effects of the present invention are obtained. In addition, the configurations or the like illustrated in the accompanying drawings can be appropriately modified and executed without departing from the scope of the purpose of the present invention.

Each of the embodiments described above is described on the assumption that each of components for enabling a function is a part different from one another, but a part that can be clearly separated and identified in such a manner does not actually need to be included. A remote work supporting device enabling the function of each of the embodiments described above may include each component for enabling the function constituted by, for example, actually different parts, or may include all the components mounted on one LSI. That is to say, each of the components is included as the function in any mounting manner. Each of the components of the present invention can be arbitrarily selected, and the present invention includes the invention including the selected configuration.

Each of the parts may be processed by recording a program for enabling such function described in each of the embodiments described above on a computer-readable recording medium and causing a computer system to read the program recorded on the recording medium for execution. Note that it is assumed that the “computer system” herein includes an OS and hardware components such as a peripheral device.

It is also assumed that the “computer system” includes a home page providing environment (or displaying environment) if a WWW system is used.

Furthermore, “computer-readable recording medium” refers to a portable medium, such as a flexible disk, a magneto-optical disk, a ROM, and a CD-ROM, and a memory, for example, a hard disk built into the computer system. Moreover, the “computer-readable recording medium” may include a medium that dynamically retains the program for a short period of time, such as a communication line that is used to transmit the program over a network such as the Internet or over a communication circuit such as a telephone circuit, and a medium that retains, in that case, the program for a fixed period of time, such as a volatile memory within the computer system which functions as a server or a client.

Furthermore, the above-described program may be configured to enable some of the functions described above, and additionally may be configured to enable the functions described above, in combination with a program already recorded in the computer system.

### Examples Realized by Software

Each of the functional blocks of the marker information manager 1405 illustrated in FIG. 5 may be realized by a logic circuit (hardware) formed by an integrated circuit (IC chip) or the like, or may be realized by software with a Central Processing Unit (CPU).

In the latter case, the marker information manager 1405 includes a CPU executing commands of a program as software for enabling each function, a Read Only Memory (ROM) or a storage device (collectively referred to as a “recording medium”) in which the above-described program and various pieces of data readable by a computer (or CPU) are recorded, a Random Access Memory (RAM) developing the above-described program, or the like. Then, the purpose of the present invention is achieved by reading the above-described program from the above-described recording medium by the computer (or CPU) for execution. As the above-described recording medium, a “non-temporarily material medium” such as a tape, a disk, a card, a semiconductor memory, and a programmable logic circuit can be used. The above-described program may be supplied to the above-described computer via an arbitrary transmission medium (such as a communication network and a broadcast wave) capable of transmitting the program. Note that the present invention may also be achieved by a form of a data signal in which the above-described program is implemented by electrical transmission and embedded in a carrier wave.

### SUMMARY

An information processing device (instruction device 1112) according to an aspect 1 of the present invention is an information processing device that performs processing concerned with an image captured in at least two viewpoints. The information processing device includes: an image acquisition unit (feature point detector 1501) configured to acquire a first image captured at a first viewpoint and a second image captured at a second viewpoint; a positional information acquisition unit (marker information storage unit 1500) configured to acquire first positional information being positional information about a marker superimposed on the first image; an inter-image transformation parameter calculator (1504) configured to make reference to the first image and the second image and calculate an inter-image transformation parameter for transforming the first image to the second image; and a marker information transformer (1505) configured to make reference to the inter-image transformation parameter and transform the first positional information to second positional information being positional information about a marker superimposed on the second image.

According to the configuration above, the first positional information being the positional information about the marker superimposed on the first image is transformed to the second positional information being the positional information about the marker superimposed on the second image. In this way, a marker superimposed on a specific image by an instructor can be superimposed on another image. Therefore, a worker can make reference to a marker superimposed on an image captured at his/her viewpoint, so that an instructor can efficiently give instructions to multiple workers.

In an information processing device according to an aspect 2 of the present invention in the aspect 1 above, the inter-image transformation parameter calculator may make reference to corresponding portions between the first image and the second image and may calculate the inter-image transformation parameter.

According to the configuration above, the inter-image transformation parameter is calculated from the corresponding portions between the two images, so that the inter-image transformation parameter can be precisely calculated.

An information processing device according to an aspect 3 of the present invention in the aspect 2 above may further include a feature point detector (1501) configured to detect a feature point from each of the first image and the second image. The inter-image transformation parameter calculator may make reference to a feature point of the first image and a feature point of the second image detected by the feature point detector as the corresponding portions and may calculate the inter-image transformation parameter.

According to the configuration above, the feature points are detected from the two images and the inter-image transformation parameter is calculated from the feature points, so that the inter-image transformation parameter can be calculated even in a case where corresponding portions are not clear beforehand.

An information processing device according an aspect 4 of the present invention in the aspects 1 to 3 above may further include an image trans former configured to make reference to the inter-image transformation parameter and to transform the first image to an image from the second viewpoint.

According to the configuration above, the first image is transformed to the image from the second viewpoint, so that the first image and the second image can be displayed as images from the same second viewpoint. In this way, a user can look at images of the same object captured at different viewpoints as images from the same viewpoint.

Note that the “second image” and the “image from the second viewpoint” are different from each other. The “second image” is an image captured at the second viewpoint. On the other hand, the “image from the second viewpoint” is an image seen from the second viewpoint, which has been transformed from an image captured at another viewpoint.

An information processing device according to an aspect 5 of the present invention in the aspects 1 to 4 above may further include an information combining unit (video combining unit 1401, marker information manager 1405) configured to specify a capturing range and a capturing direction of a first image in the second image and to include information indicating the capturing range and the capturing direction in the second image.

According to the configuration above, the capturing range and the capturing direction of the first image in the second image are specified, and the information indicating the capturing range and the capturing direction is included in the second image. In this way, a user can grasp a positional relationship and an inclusion relation between images of the same object captured at different viewpoints.

An information processing device according to an aspect 6 of the present invention in the aspects 1 to 5 above may further include: a display unit (display device 1113) configured to display at least one of the first image and the second image; and an instruction receiver (display device 1113) configured to receive a selection instruction indicating which image is selected from the first image and the second image as an image targeted for an operation to superimpose the marker. The display unit may display only the image selected from the first image and the second image as the image targeted for the operation to superimpose the marker.

According to the configuration above, when the image is displayed, only the targeted image of the first image and the second image on which the marker is superimposed is displayed. In this way, a user can look at only one large image of the images of the same object captured at different viewpoints and can thus efficiently give instructions by the marker.

An information processing device according to an aspect 7 of the present invention in the aspects 1 to 6 above may further include a frame acquisition unit (feature point detector 1501) configured to acquire a first frame being an image captured at a prescribed viewpoint at a first time point and a second frame being an image captured at the prescribed viewpoint at a second time point after the first time point. The positional information acquisition unit may acquire third positional information being positional information about a marker superimposed on the first frame. The information processing device may further include: an inter-frame transformation parameter calculator (1502) configured to make reference to the first frame and the second frame and calculate an inter-frame transformation parameter for transforming the first frame to the second frame; and a marker information updating unit (1503) configured to make reference to the inter-frame transformation parameter and update the third positional information to fourth positional information being positional information about a marker superimposed on the second frame.

According to the configuration above, the third positional information being the positional information about the marker superimposed on the first frame is updated to the fourth positional information being the positional information about the marker superimposed on the second frame. In this way, a marker superimposed on the first frame by an instructor can be superimposed on the second frame captured after the first frame. Therefore, even in a case where a captured image changes with a lapse of time, a marker can follow the image and be superimposed on the image.

A terminal (working terminals 1103, 1105) according to an aspect 8 of the present invention is a terminal that communicates with the information processing device according to the aspects 1 to 7 above. The terminal includes: a transmitter (communicator 1800) configured to transmit the second image to the information processing device; a positional information acquisition unit (communicator 1800) configured to acquire the second positional information from the information processing device; and a display unit (1802) configured to display a marker superimposed on the second image and located in a position indicating the second positional information.

According to the configuration above, the marker superimposed on the second image and located in the position indicating the second positional information is displayed. In this way, a user can look at a marker superimposed on the first image in the second image in the information processing device.

A remote communication system according to an aspect 9 of the present invention is a remote communication system that includes an information processing device, a first terminal, and a second terminal. The information processing device includes: an image acquisition unit configured to acquire a first image captured at a first viewpoint and a second image captured at a second viewpoint; a positional information acquisition unit configured to acquire first positional information being positional information about a marker superimposed on the first image; an inter-image transformation parameter calculator configured to make reference to the first image and the second image and calculate an inter-image transformation parameter for transforming the first image to the second image; and a marker information transformer configured to make reference to the inter-image transformation parameter and transform the first positional information to second positional information being positional information about a marker superimposed on the second image. The first terminal includes a transmitter configured to transmit the first image to the information processing device. The second terminal includes: a transmitter configured to transmit the second image to the information processing device; a positional information acquisition unit configured to acquire the second positional information from the information processing device; and a display unit configured to display at least one of a marker superimposed on the second image and located in a position indicated by the second positional information and information indicating a capturing range and a capturing direction of the first image in the second image.

The present invention is not limited to each of the embodiments described above. Various modifications are possible within the scope defined by claims, and embodiments that are made by suitably combining technical measures disclosed in the different embodiments are also included in the technical scope of the present invention. Furthermore, a new technical feature can be formed by combining technical means disclosed in each of the embodiments.

### INDUSTRIAL APPLICABILITY

The present invention can be used for an information processing device that performs processing concerned with an image captured in at least two viewpoints, a terminal, and a remote communication system.

### REFERENCE SIGNS LIST

1103, 1105 Working terminal (terminal)
1112 Instruction device (information processing device)
1113 Display device (display unit, instruction receiver)
1401 Video combining unit (image transformer, information combining unit)
1405 Marker information manager (information combining unit)
1500 Marker information storage unit (positional information acquisition unit)
1501 Feature point detector (image acquisition unit, frame acquisition unit)
1502 Inter-frame transformation parameter calculator
1503 Marker information updating unit
1504 Inter-image transformation parameter calculator
1505 Marker information transformer
1800 Communicator (transmitter, positional information acquisition unit)
1802 Display unit

1-9. (canceled)

10. An information processing device, the information processing device comprising:
an image acquisition circuitry configured to acquire a first image captured at a first viewpoint and a second image captured at a second viewpoint;
a positional information acquisition circuitry configured to acquire first positional information about a first marker superimposed on the first image; and
a communication circuitry configured to transmit at least one of:
(i) second positional information comprising:
(a) position information about a second marker, for identifying where on the second image the second marker is to be superimposed, and
(b) a position on the second image corresponding to the position on the first image indicated by the first positional information; and
(ii) the second image in which the first marker is superimposed thereon at a position on the second image corresponding to the first positional information.

11. An information processing device, the information processing device comprising:
an image acquisition circuitry configured to acquire a first image captured at a first viewpoint and a second image captured at a second viewpoint;
a positional information acquisition circuitry configured to acquire first positional information being positional information about a marker superimposed on the first image; and
a display circuitry configured to display the second image in which a marker is superimposed on a position thereon corresponding to a position on the first image which position is indicated by the first positional information.

12. The information processing device according to claim 11, wherein
the display circuitry displays the second image which is obtained by transforming an image from the second viewpoint to an image from the first viewpoint.

13. The information processing device according to claim 11, wherein
the display circuitry superimposes, on the second image, an image indicating a capturing range and a capturing direction of the first image in the second image.

14. The information processing device according to claim 10, further comprising:
a display circuitry; and
an instruction receiver configured to receive a selection instruction indicating which image is selected from the first image and the second image as an image targeted for an operation to superimpose the marker, wherein
the display circuitry is configured to display only the image selected from the first image and the second image as the image targeted for the operation to superimpose the marker.

15. The information processing device according to claim 11, further comprising:
an instruction receiver configured to receive a selection instruction indicating which image is selected from the first image and the second image as an image targeted for an operation to superimpose the marker, wherein
the display circuitry is configured to display only the image selected from the first image and the second image as the image targeted for the operation to superimpose the marker.

16. The information processing device according to claim 10, further comprising a frame acquisition circuitry configured to acquire a first frame being an image captured at a prescribed viewpoint at a first time point and a second frame being an image captured at the prescribed viewpoint at a second time point after the first time point, wherein
the positional information acquisition circuitry is configured to acquire third positional information being positional information about a marker superimposed on the first frame, and
the information processing device further includes
a marker information updating circuitry configured to make reference to the first frame and the second frame and update the third positional information to fourth positional information being positional information about a marker superimposed on the second frame.

17. A terminal that communicates with the information processing device according to claim 10, the terminal comprising:
a transmitter configured to transmit the second image to the information processing device;
a positional information acquisition circuitry configured to acquire the second positional information from the information processing device; and
a display circuitry configured to display a marker superimposed on the second image and located in a position indicating the second positional information.

18. A remote communication system that includes an information processing device, a first terminal, and a second terminal, wherein the information processing device includes
an image acquisition circuitry configured to acquire a first image captured at a first viewpoint and a second image captured at a second viewpoint,
a positional information acquisition circuitry configured to acquire first positional information about a first marker superimposed on the first image, and
a communication circuitry configured to transmit at least one of:
(i) second positional information comprising:
(a) position information about a second marker, for identifying where on the second image the second marker is to be superimposed, and
(b) a position on the second image corresponding to the position on the first image indicated by the first positional information; and
(ii) the second image in which the first marker is superimposed thereon at a position on the second image corresponding to the first positional information,
wherein the first terminal includes a transmitter configured to transmit the first image to the information processing device, and
the second terminal includes
a transmitter configured to transmit the second image to the information processing device,
a positional information acquisition circuitry configured to acquire the second positional information from the information processing device, and
a display circuitry configured to display at least one of a marker superimposed on the second image and located in a position indicated by the second positional information and an image indicating a capturing range and a capturing direction of the first image in the second image.

19. A non-transitory medium storing therein an information processing program for causing a computer to function as the information processing device according to claim 10, the information processing program causing the computer to function as each of the image acquisition circuitry, the positional information acquisition circuitry, and the communication circuitry.

20. A non-transitory medium storing therein an information processing program for causing a computer to function as the information processing device according to claim 11, the information processing program causing the computer to function as each of the image acquisition circuitry, the positional information acquisition circuitry, and the display circuitry.
